(19) United States
(12) Patent Application Publication
(10) Pub. No.: US 2007/0092778 A1
(43) Pub. Date: Apr. 26, 2007

(54) Oligomer solid acid and polymer electrolyte membrane including the same

(76) Inventors: Myung-sup Jung, Seongnam-si (KR); Do-yun Kim, Seongnam-si (KR); Jin-gyu Lee, Seoul (KR); Jae-jun Lee, Suwon-si (KR)

Correspondence Address: CHRISTIE, PARKER & HALE, LLP, PO BOX 7068, PASADENA, CA, 91109-7068, US

(21) Appl. No.: 11/546,005

(22) Filed: Oct. 10, 2006

(30) Foreign Application Priority Data
Oct. 10, 2005 (KR) 10-2005-0094935

(51) Int. Cl. H01M 8/10; H01M 4/94; C08J 5/20

(52) U.S. Cl. 429/33; 429/44; 521/25

(57) ABSTRACT

An oligomer solid acid and a polymer electrolyte membrane using the same. The polymer electrolyte membrane includes a macromolecule of oligomer solid acid having an ionically conductive terminal group at its terminal end and the minimum amount of ionically conductive terminal groups required for ion conduction, thus suppressing swelling and allowing a uniform distribution of the oligomer solid acid, thereby improving ionic conductivity. Since the number of ionically conductive terminal groups in the polymer electrolyte membrane is minimized and the polymer matrix in which swelling is suppressed is used, methanol crossover and difficulties of outflow due to a large volume are minimized, and a macromolecule of the oligomer solid acid having the ionically conductive terminal groups on the surface thereof is uniformly distributed. Accordingly, ionic conductivity is high and thus, the polymer electrolyte membrane shows good ionic conductivity even in low humidity conditions.

### CROSS-REFERENCE TO RELATED PATENT APPLICATION

This application claims priority to and the benefit of Korean Patent Application No. 10-2005-0094935, filed on Oct. 10, 2005, in the Korean Intellectual Property Office, the disclosure of which is incorporated herein in its entirety by reference.

### BACKGROUND OF THE INVENTION

1. Field of the Invention

The present invention relates to an oligomer solid acid and a polymer electrolyte membrane using the same, and more particularly, to an oligomer solid acid which provides high ionic conductivity and a polymer electrolyte membrane with excellent ionic conductivity and low methanol crossover.

2. Description of the Related Art

A fuel cell is an electrochemical device which directly transforms chemical energy of both oxygen and hydrogen contained in a hydrocarbon material such as methanol, ethanol, and natural gas into electric energy. The energy transformation process of a fuel cell is very efficient and environmentally-friendly.

Fuel cells can be classified into Phosphoric Acid Fuel Cells (PAFC), Molten Carbonate Fuel Cells (MCFC), Solid Oxide Full Cells (SOFC), Polymer Electrolyte Membrane Fuel Cells (PEMFC), and Alkaline Full Cells (AFC) according to the type of electrolyte used. All fuel cells operate on the same principle, but the type of fuel used, operating temperature, the catalyst used and the electrolyte used are different. In particular, a PEMFC is capable of being used in small-sized stationary power generation equipment or a transportation system due to its low operating temperature, high output density, rapid start-up, and prompt response to the variation of output demand.

The core part of a PEMFC is a Membrane Electrode Assembly MEA. An MEA generally comprises a polymer electrolyte membrane and an electrode attached to each side of the polymer electrolyte membrane, which independently act as a cathode and an anode.

The polymer electrolyte membrane acts as a separator blocking the direct contact between an oxidizing agent and a reducing agent, and electrically insulates the two electrodes while conducting protons. Accordingly, a good polymer electrolyte membrane has high proton conductivity, good electrical insulation, low reactant permeability, excellent thermal, chemical and mechanical stability under normal conditions of fuel cell operation, and a reasonable price.

In order to meet these requirements, various types of polymer electrolyte membranes have been developed, and, in particular, a highly fluorinated polysulfonic acid membrane such as a NAFION™ membrane is a standard due to excellent durability and performance. However, for excellent performance, the NAFION™ membrane should be sufficiently humidified, and to prevent moisture loss, the NAFION™ membrane should be used at a temperature of 80° C. or below. Also, since, a carbon-carbon bond of the main chain is attacked by oxygen (O₂), the NAFION™ membrane is not stable under the operating conditions of a fuel cell.

Moreover, in a Direct Methanol Fuel Cell (DMFC), an aqueous methanol solution is supplied as a fuel to the anode and a portion of unreacted aqueous methanol solution is permeated to the polymer electrolyte membrane. The methanol solution that permeates the polymer electrolyte membrane causes a swelling phenomenon in an electrolyte membrane to diffuse to a cathode catalyst layer. Such a phenomenon is referred to as ‘methanol crossover’, the direct oxidization of methanol at the cathode where an electrochemical reduction of hydrogen ions and oxygen occurs, and thus the methanol crossover results in a drop in the electric potential of the cathode, thereby causing a significant decline in the performance of the fuel cell.

This issue is common in other fuel cells using a liquid fuel in which a polar organic fuel other than methanol is included.

### SUMMARY OF THE INVENTION

One embodiment of the present invention provides an oligomer solid acid which can provide ionic conductivity to a polymer electrolyte membrane and is not separated easily from the polymer electrolyte membrane.

Another embodiment of the present invention provides a polymer electrolyte membrane including the oligomer solid acid which shows excellent ionic conductivity, even without humidifying, and low methanol crossover.

Yet another embodiment of the present invention provides a Membrane Electrode Assembly (MEA) including the polymer electrolyte membrane.

An embodiment of the present invention provides a fuel cell including the polymer electrolyte membrane.

According to an embodiment of the present invention, an oligomer solid acid is provided including: (a) a main chain having a degree of polymerization of 10 to 70; and (b) a side chain having the structure represented by Formula 1 bonded to a repeating unit of the main chain:
-E₁- . . . -Eᵢ- . . . -Eₙ Formula 1
where each Eᵢ included in E₁ through Eₙ₋₁ is independently one of the organic groups represented by Formula 2 through Formula 6, 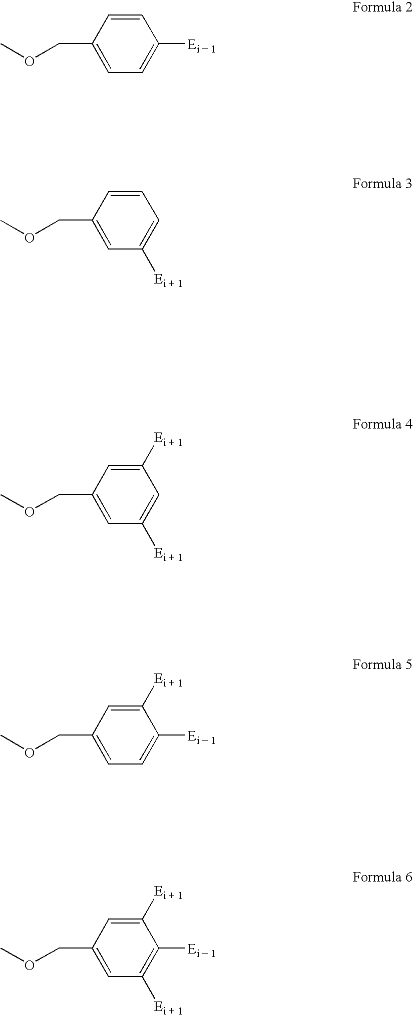
where each Eᵢ₊₁ of Formula 4 through Formula 6 can be independently the same or different, the number of Eᵢ₊₁ of the (i+1)^{th} generation bonded with Eᵢ of the i^{th} generation is the same as the number of available bonds existing in Eᵢ, n is an integer in the range of 2 to 4 and indicates the generation of a branching unit; and Eₙ is one of —SO₃H, —COOH, —OH, and —OPO(OH)₂.

It should be apparent to one of skill in the art that the individual side chains of the side chains of Formula 1 are not limited to straight chain branches, but rather, each branch may have further branches depending on the number of Eᵢ+1 bonding sites for a particular Eᵢ organic group at the i^{th} level of the corresponding dendrimer.

According to another embodiment of the present invention, a polymer electrolyte membrane is provided including at least one polymer matrix having an end group selected from the group consisting of —SO₃H, —COOH, —OH, and —OPO(OH)₂ at the terminal of a side chain, and the oligomer solid acid uniformly distributed through the polymer matrixes.

According to another embodiment of the present invention, a Membrane Electrode Assembly (MEA) is provided including: a cathode having a catalyst layer and a diffusion layer; an anode having a catalyst layer and a diffusion layer; and an electrolyte membrane interposed between the cathode and the anode, the electrolyte membrane including the polymer electrolyte membrane of the present invention.

According to another embodiment of the present invention, a fuel cell is provided including: a cathode having a catalyst layer and a diffusion layer; an anode having a catalyst layer and a diffusion layer; and an electrolyte membrane interposed between the cathode and the anode, the electrolyte membrane including the polymer electrolyte membrane of the present invention.

### BRIEF DESCRIPTION OF THE DRAWINGS

The above and other embodiments of the present invention will become more apparent by describing in detail exemplary embodiments thereof with reference to the attached drawings in which:

FIG. 1 is a graph showing the results of a Nuclear Magnetic Resonance (NMR) analysis performed to identify the structure of a compound in Formula 19;

FIG. 2 is a graph showing the result of a NMR analysis performed to identify the structure of a compound in Formula 20;

FIG. 3 is a graph showing the result of a NMR analysis performed to identify the structure of a compound in Formula 22;

FIG. 4 is a graph showing the results of a Fourier Transform Infrared Spectroscopy (FT-IR) analysis performed to identify the structure of a compound in Formula 23;

FIG. 5 is a fuel cell according to an embodiment of the invention; and

FIG. 6 is a Membrane Electrode Assembly (MEA) according to an embodiment of the invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein.

An oligomer solid acid according to an embodiment of the present invention includes a main chain having a degree of polymerization of 10 to 70; and a side chain having the structure represented by Formula 1 bonded to a repeating unit of the main chain:
-E₁- . . . -Eᵢ- . . . -Eₙ Formula 1
where each Eᵢ included in E₁ through Eₙ₋₁ is independently one of the organic groups represented by Formula 2 through Formula 6, 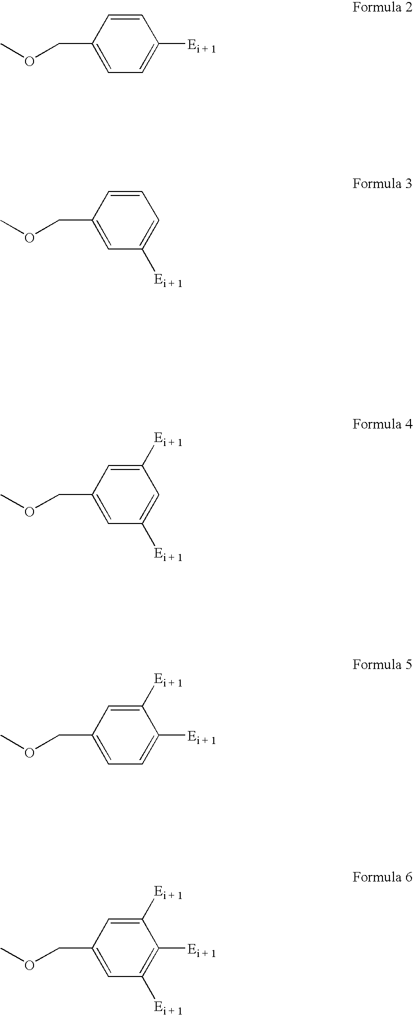
where each Eᵢ₊₁ of Formula 4 through Formula 6 can be independently the same or different, the number of Eᵢ₊₁ of the (i+1)^{th} generation bonded with Eᵢ of the i^{th} generation is the same as the number of available bonds existing in Eᵢ, n is an integer in the range of 2 to 4 and indicates the generation of a branching unit; and Eₙ is one of —SO₃H, —COOH, —OH, and —OPO(OH)₂.

If the oligomer solid acid of one embodiment is distributed between polymer matrixes, outflow due to swelling hardly occurs since the oligomer solid acid has a significantly large size. Also, the oligomer solid acid of an embodiment provides ionic conductivity to a polymer electrolyte membrane since an acidic functional group such as —COOH, —SO₃H, or —OPO(OH)₂ attached to a terminal provides high ionic conductivity.

In the main chain of the oligomer solid acid according to another embodiment, the degree of polymerization may be 10 to 70, for example, 20 to 50. When the degree of polymerization of the main chain is less than 10, the molecular weight of the whole oligomer molecule in which the side chain is included may be less than 10,000. In this case, the size of the molecule is too small, and thus it is likely that the oligomer solid acid will outflow. When the degree of polymerization of the main chain is greater than 70, the molecular weight of the whole oligomer molecule in which the side chain is included may exceed 40,000. In this case, the properties of the oligomer solid acid may be difficult to control and the domain size of the solid acid formed by a phase separation from a matrix in the polymer membrane is significantly large.

In one embodiment, the repeating unit of the main chain may be the repeating unit of polystyrene, polyethylene, polyimide, polyamide, polyacrylate, polyamic ester or polyaniline.

In particular, the repeating unit of the main chain may be a unit represented by one of Formula 7 through Formula 9, but is not limited thereto.

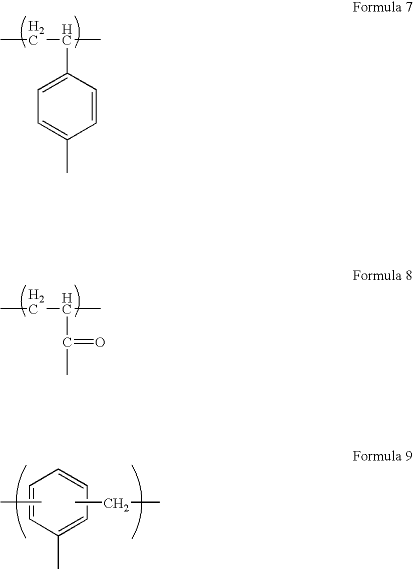

The side chain which bonds to the repeating unit of the main chain may be a chain represented by one of Formula 10 through Formula 15 below, but is not limited thereto. 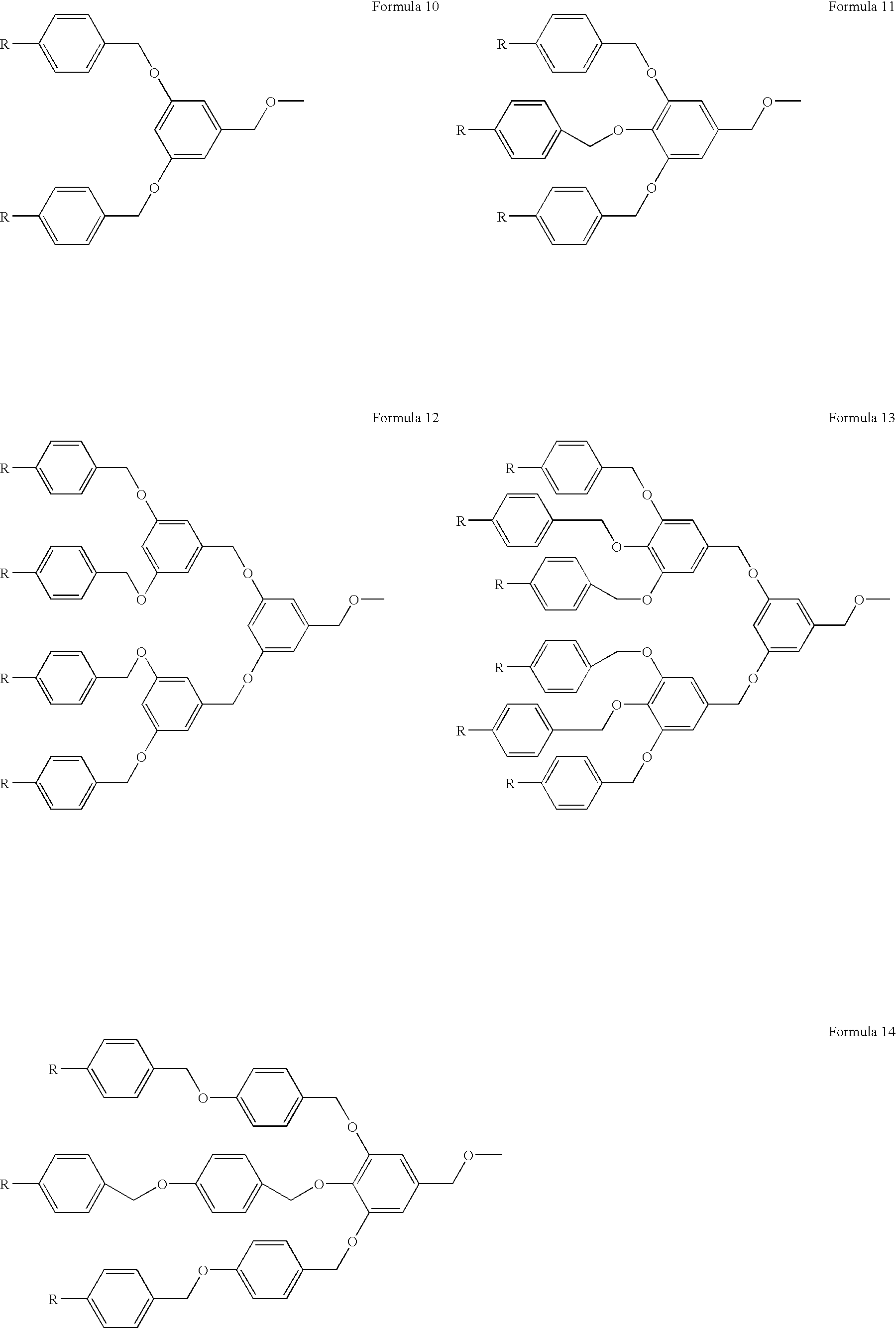 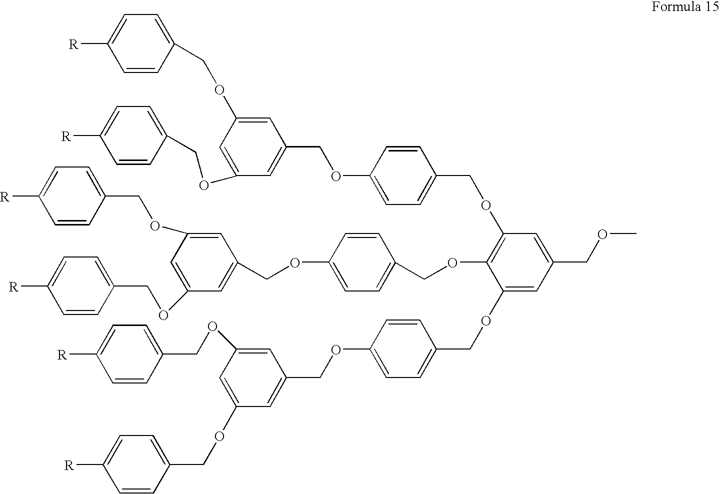
Here, R is one of —SO₃H, —COOH, —OH, and —OPO(OH)₂.

The molecular weight of the oligomer solid acid according to one embodiment may be 10,000 to 40,000. When the molecular weight is below 10,000, the size of the molecule is too small, and thus it is likely that the oligomer solid acid will outflow. When the molecular weight is above 40,000, the properties of the oligomer solid acid may be difficult to control and the domain size of the solid acid formed by a phase separation from a matrix in the polymer membrane is significantly large.

The dendrimer solid acid according to an embodiment of the present invention will now be described in greater detail with reference to a process of manufacturing the dendrimer solid acid represented by Reaction Schemes 1 and 2. The method is provided to facilitate the understanding of the present invention, but the present invention is not limited by the reaction schemes set forth herein.

According to one embodiment, first, as shown in Reaction Scheme 1, a monomer forming the side chain can be synthesized.

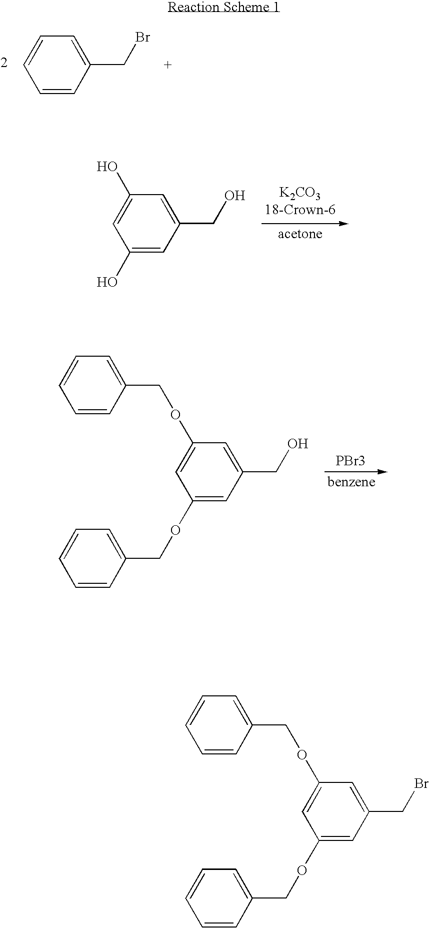

A side chain unit having multiple generations can be manufactured by repeating the method shown in Reaction Scheme 1.

Then, as shown in Reaction Scheme 2, the above side chain unit is reacted with a compound forming the main chain to manufacture the oligomer solid acid according to an embodiment of the present invention.

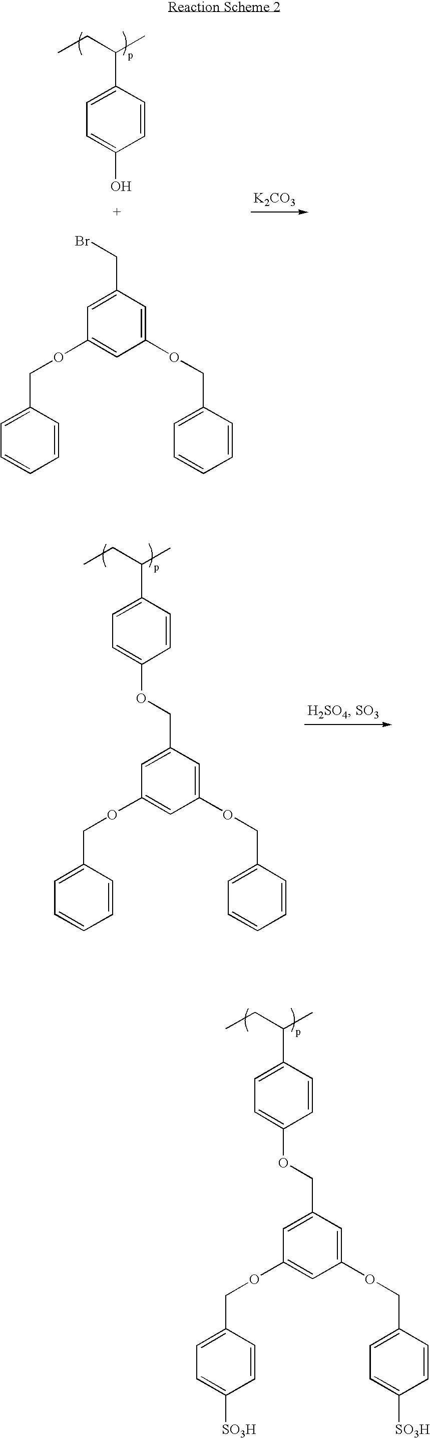

In an embodiment, p is an integer determined such that the molecular weight of the compound which forms the main chain is 2,000 through 8,000.

In order to have a functional group such as —COOH, —OH, or —OPO(OH)₂ at the terminal of the oligomer solid acid, a structure in which the functional group such as —COOH, —OH, or —OPO(OH)₂ is protected by an alkyl group during the branching structure synthesis. That is, the functional group is included in a benzyl halide compound having a structure of —COOR, —OR, or —OPO(OR)₂. Then, the polymer with the low molecular weight is prepared and the oligomer solid acid can be subsequently manufactured by detaching an alkyl group. In one embodiment, R is, for example, a monovalent C₁₋₅ alkyl group.

A polymer electrolyte membrane according to an embodiment of the present invention will now be described.

A polymer electrolyte membrane according to an embodiment of the present invention includes at least one polymer matrix having an end group selected from the group consisting of —SO₃H, —COOH, —OH, and —OPO(OH)₂ at the terminal of a side chain, and an oligomer solid acid uniformly distributed through the polymer matrixes.

The polymer matrixes may be a polymer material selected from the group consisting of polyimide, polybenzimidazole, polyethersulfone, and polyether-ether-ketone.

The polymer electrolyte membrane can have ionic conductivity since the oligomer solid acid according to an embodiment of the present invention is uniformly distributed throughout the polymer matrix. That is, both acidic functional groups at the terminal of the side chain of the polymer matrix and acidic functional groups existing on the surface of the oligomer solid acid interact together to provide high ionic conductivity.

Conventionally, a large amount of an ionically conductive terminal group such as a sulfone group is attached to a polymer forming matrix in a conventional polymer electrolyte membrane, thereby causing swelling. However, according to an embodiment, in the polymer matrix described herein, only the minimum amount of an ionically conductive terminal group required for ionic conduction is attached to prevent swelling caused by moisture.

In particular, the polymer matrix herein may be a polymer resin represented by Formula 16 below: 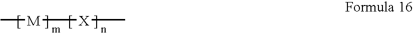
where M is a repeating unit of Formula 17 below, 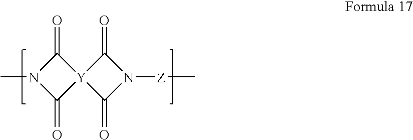
where Y is a tetravalent aromatic organic group or aliphatic organic group and Z is a bivalent aromatic organic group or aliphatic organic group; X in Formula 16 is a repeating unit of Formula 18 below, 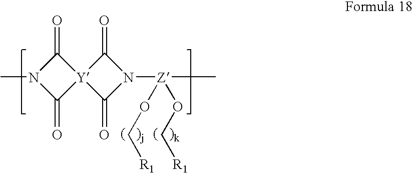
where Y′ is a tetravalent aromatic organic group or aliphatic organic group, Z′ is a tetravalent aromatic organic group or aliphatic organic group, j and k are each independently an integer in the range of 1 to 6, and R₁ is one of —OH, —SO₃H, —COOH, and —OPO(OH)₂; and m and n are each independently in the range of 30 to 5000.

In an embodiment, the ratio of m to n may be between 2:8 and 8:2, for example, between 4:6 and 6:4. When the ratio of m to n is less than 2:8, swelling and methanol crossover due to water are increased. When the ratio of m to n is greater than 8:2, hydrogen ion conductivity is too low to secure an optimum level of hydrogen ion conductivity even when the solid acid is added.

For example, M and X, which are repeating units of the polymer resin of Formula 16, may have the structures represented by Formula 24 and Formula 25, respectively: 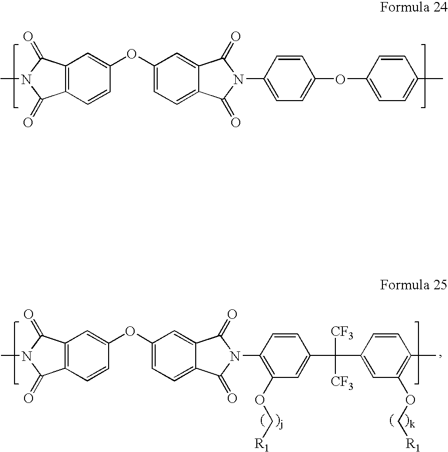
where j and k are each independently a fixed number in the range of 1 to 6 and R₁ is one of —OH, —SO₃H, —COOH, and —OPO(OH)₂.

The process of manufacturing the polymer matrix according to Formula 16 is not particularly restricted, and may be the process illustrated in Reaction Scheme 3.

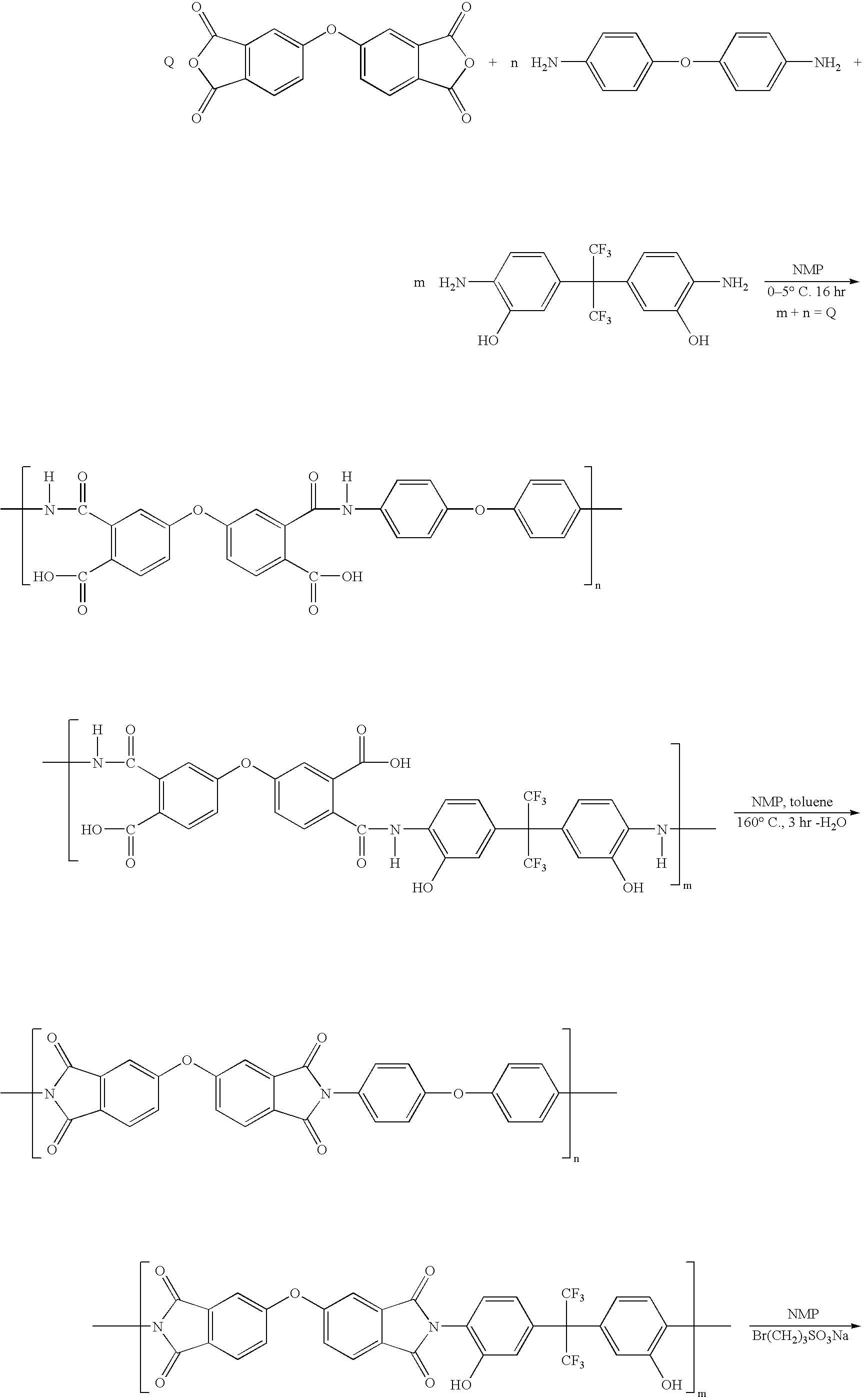

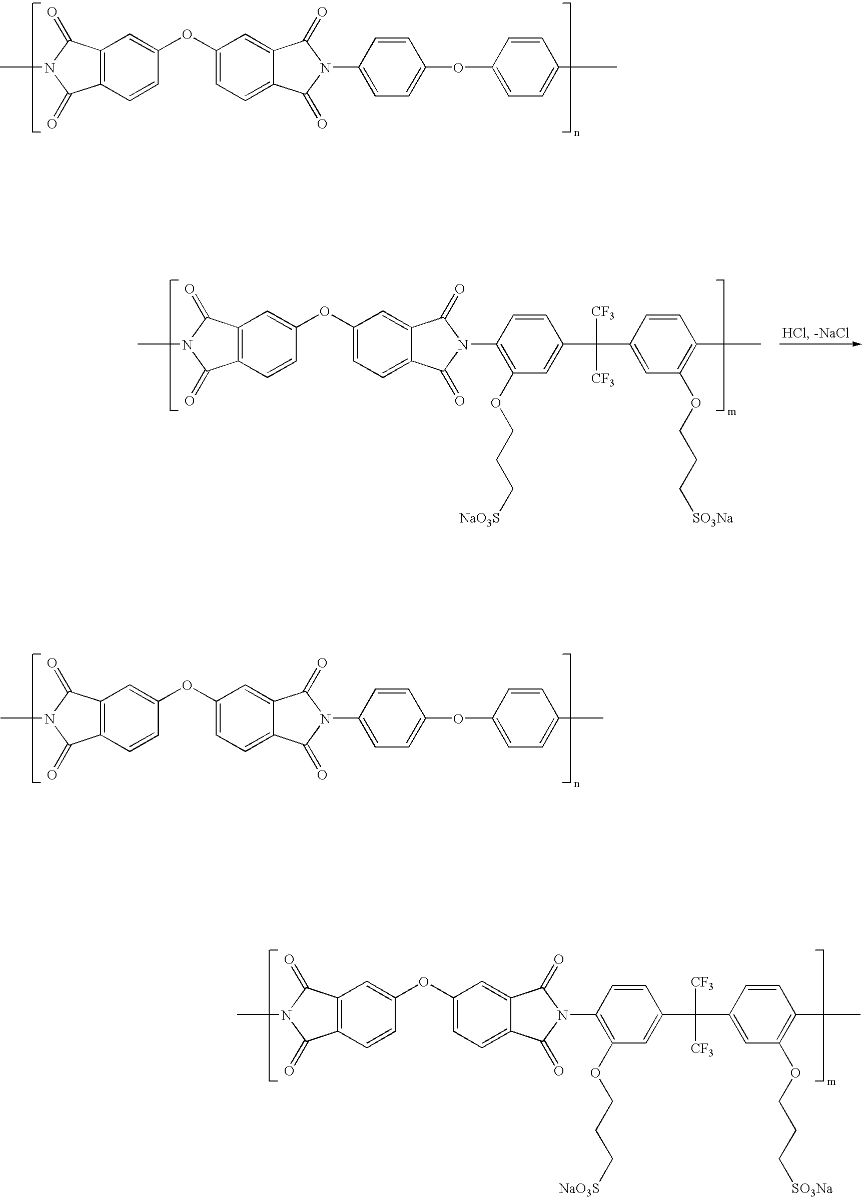

A Membrane Electrode Assembly (MEA) including the polymer electrolyte membrane according to an embodiment of the present invention will now be described. The MEA includes: a cathode having a catalyst layer and a diffusion layer; an anode having a catalyst layer and a diffusion layer; and an electrolyte membrane interposed between the cathode and the anode, the electrolyte membrane including the polymer electrolyte membrane according to an embodiment of the present invention.

The cathode and anode both having a catalyst layer and a diffusion layer may be those that are well known in the field of fuel cells. Also, the electrolyte membrane includes the polymer electrolyte membrane according to an embodiment of the present invention. The polymer electrolyte membrane according to an embodiment of the present invention can be used alone as an electrolyte membrane or can be combined with another membrane having ionic conductivity.

A fuel cell according to an embodiment of the present invention including the polymer electrolyte membrane will now be described.

The fuel cell includes: a cathode having a catalyst layer and a diffusion layer; an anode having a catalyst layer and a diffusion layer; and an electrolyte membrane interposed between the cathode and the anode, the electrolyte membrane including the polymer electrolyte membrane according to an embodiment of the present invention.

The cathode and anode both having a catalyst layer and a diffusion layer may be those that are well known in the field of fuel cells. Also, the electrolyte membrane includes the polymer electrolyte membrane according to an embodiment of the present invention. The polymer electrolyte membrane according to an embodiment of the present invention can be used alone as an electrolyte membrane or can be combined with another membrane having ionic conductivity.

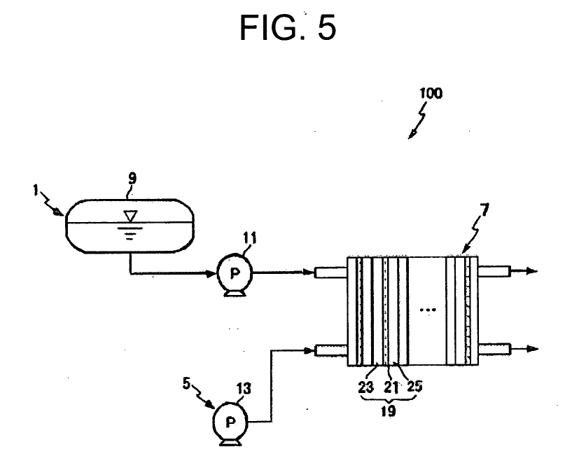

In one embodiment, as shown in FIG. 5, the fuel cell 100 includes a fuel supplier 1, an oxygen supplier 5, and a fuel cell stack 7. The fuel supplier 1 includes a fuel tank 9 for containing a fuel such as methanol and a fuel pump 11 for supplying the fuel to the stack 7. The oxygen supplier 5 includes an oxygen pump 13 for supplying oxygen from air to the stack 7. The stack includes a plurality of electricity generating units 19, each comprising a Membrane Electrode Assembly 21 and separators 23 and 25. Each Membrane Electrode Assembly 21 comprises a polymer electrode member with an anode on a first side and a cathode on a second side.

To manufacture the fuel cell, a conventional method can be used, and thus, a detailed description is omitted herein.

The polymer electrolyte membrane according to an embodiment of the present invention minimizes the methanol crossover by using the polymer matrix which suppresses swelling by minimizing the number of ion conductive terminal groups and significantly improves the ionic conductivity by distributing the oligomer solid acid macromolecules which has ion conductive terminal groups on the surface and a large volume, thereby hardly escaping the polymer matrix in which they are distributed. Accordingly, the polymer electrolyte membrane according to an embodiment of the present invention sustains high ionic conductivity even in non-humidified conditions.

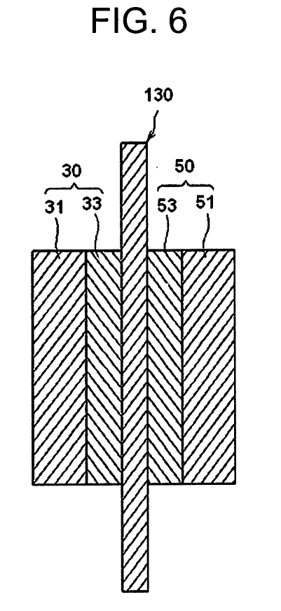

In an embodiment, as shown in FIG. 6, a Membrane Electrode Assembly (MEA) of the present invention includes an anode 30 to which a fuel is supplied, a cathode 50 to which an oxidant is supplied, and an electrolyte membrane 130 interposed between the anode 30 and the cathode 50. The anode 30 can be composed of an anode diffusion layer 31 and an anode catalyst layer 33 and the cathode 50 can be composed of a cathode diffusion layer 51, and a cathode catalyst layer 53.

The present invention will be described in greater detail with reference to the following examples. The following examples are for illustrative purposes only, and are not intended to limit the scope of the invention.

### EXAMPLE 1

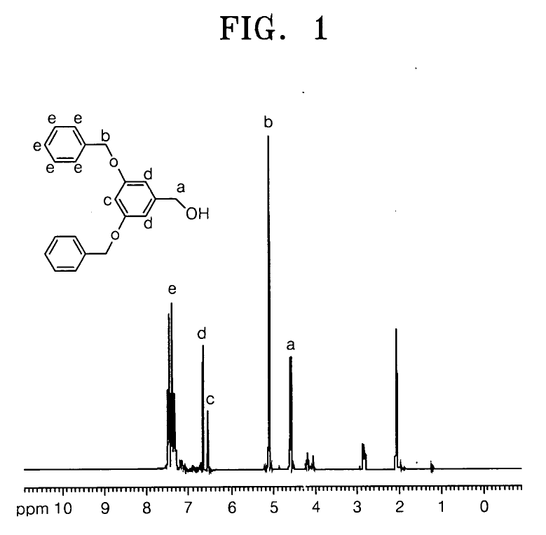

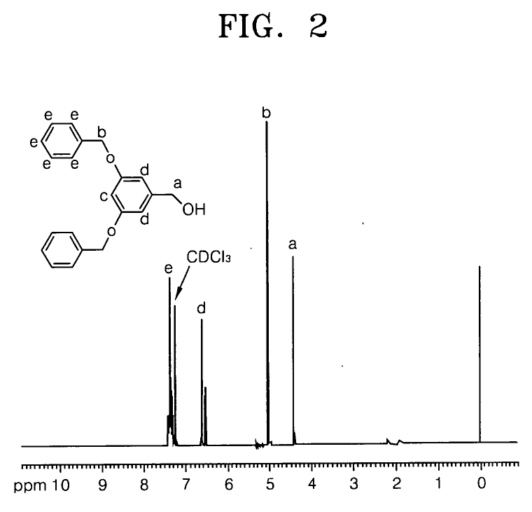

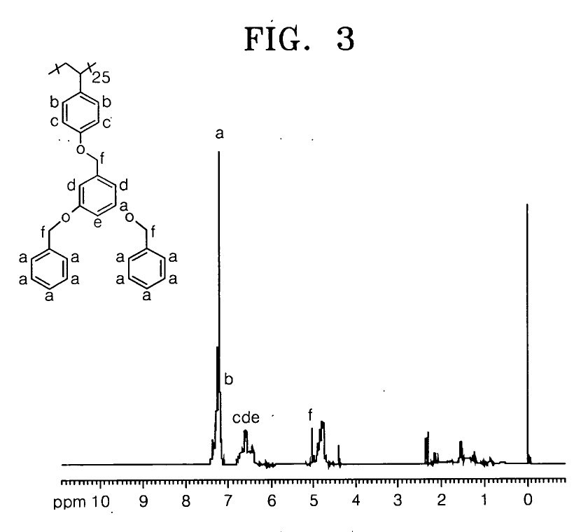

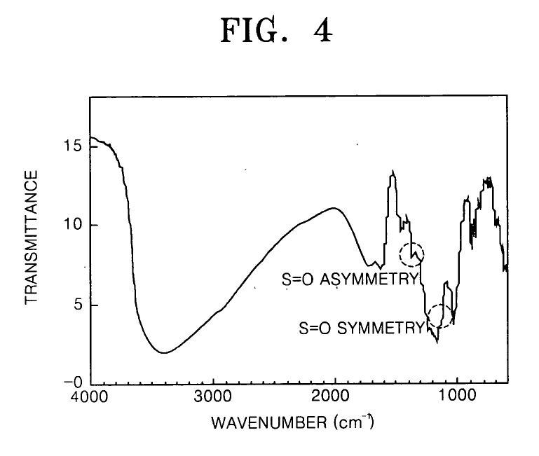

0.38 moles of benzyl bromide, 0.18 moles of 3,5-Dihydroxy benzyl alcohol, 0.36 moles of K₂CO₃ and 0.036 moles of 18-crown-6 were dissolved in acetone and refluxed at 60° C. for 24 hours. The mixture was cooled to room temperature. Then the acetone was removed by distillation and was extracted using an ethylacetate/sodium hydroxide solution to separate an organic layer from the mixture. The separated organic layer was dried using MgSO₄ and the solvent was distilled and removed. The resulting product was recrystallized with ether/hexane and refined to obtain 37 g of the compound in Formula 19 as a white crystalline solid (Yield: 67%). The structure of compound in Formula 19 was identified using Nuclear Magnetic Resonance (NMR) analysis, and the results are shown in FIG. 1. 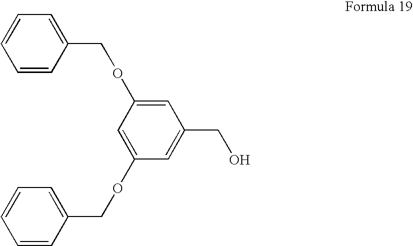
20 g (0.065 moles) of the compound of Formula 19 was dissolved in 50 ml of benzene at 0° C., and then a solution in which 6.4 g (0.0238 moles) of PBr₃ was dissolved in benzene was added dropwise to the resulting product and stirred for 15 minutes. Then, the temperature of the resulting product was raised to an ambient temperature and stirred for 2 hours. The mixture was then put into an ice bath and the benzene was distilled to be removed. After extracting an aqueous phase using ethylacetate, the organic layer was separated and dried using MgSO₄ and the solvent was removed by distillation. The result was recrystallized with toluene/ethanol and was refined to obtain 19 g of the compound in Formula 20 as a white crystalline solid (Yield: 79%). The structure of the compound in Formula 20 was identified using NMR analysis, and the results are shown in FIG. 2. 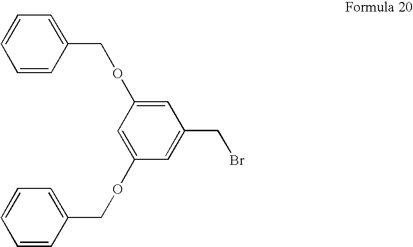
8.4 g of the compound of Formula 20 thus synthesized, 2.42 g of commercially available polyhydroxystyrene (PHSt: compound of Formula 21, Mw=3000, manufactured by Nippon Soda, Japan), 2.8 g of K₂CO₃ and 1.1 g of 18-crown-6 were dissolved in 200 ml of tetrahydrofuran (THF) and refluxed at 60° C. for 24 hours. The reaction mixture was cooled to room temperature. Then the acetone was distilled to be removed and was extracted using a toluene/sodium hydroxide solution to separate a toluene layer from the reaction mixture. The separated toluene layer was dried using MgSO₄ and the toluene was distilled to be concentrated to 50 ml. The result was immersed in ethanol to obtain 8.2 g of the compound of Formula 22 as a white crystalline solid (Yield: 76%). The structure of the compound in Formula 22 was identified using NMR analysis, and the results are shown in FIG. 3. 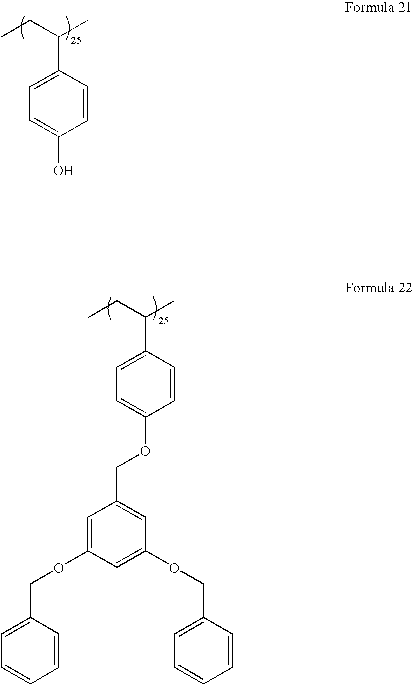
5 g of the compound of Formula 22 (oligomer solid acid precursor) thus obtained was completely dissolved in 15 ml of sulfuric acid, and then 5 ml of fumed sulfuric acid (SO₃ 60%) was added hereto. The mixture was allowed to react at 80° C. for 12 hours and then precipitated in ether. The precipitate was filtered and then dissolved in water. The resultant was put into a dialysis membrane and refined to obtain the compound of Formula 23. The structure of the compound of Formula 23 was identified using Fourier Transform Infrared Spectroscopy (FT-IR) analysis, and the results are shown in FIG. 4.

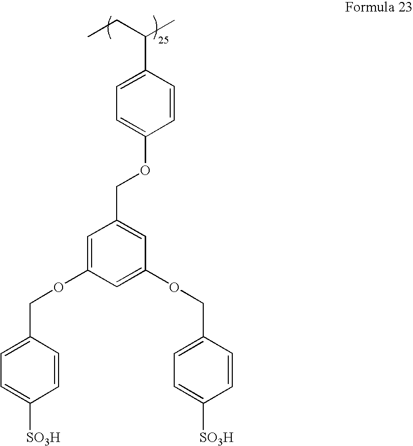

### EXAMPLE 2

100 parts by weight of the polymer matrix of Formula 16 manufactured as illustrated in Reaction Scheme 3 with the ratio of m to n being 5:5, and 6.7 parts by weight of the oligomer solid acid of Formula 23 were completely dissolved in N-methyl pyrrolidone (NMP) and casted at 110° C. to manufacture a polymer electrolyte membrane.

### EXAMPLE 3

A polymer electrolyte membrane was manufactured according to Example 2, except that 10 parts by weight of the oligomer solid acid in Formula 23 was used.

The ionic conductivity and methanol crossover were respectively measured for the polymer electrolyte membranes manufactured as in Examples 2 and 3 and a polymer membrane in which a solid acid was not included. The results are illustrated in Table 1.

TABLE 1

| | | Methanol crossover |
|---|---|---|
| | Ionic conductivity (S/cm) | (cm²/sec) |
| Polymer membrane | 2.60 × 10⁻⁶ | 2.73 × 10⁻⁹ |
| Example 2 | 1.48 × 10⁻⁴ (after 1 day) | 5.51 × 10⁻⁸ |
| Example 3 | 6.68 × 10⁻⁴ (after 1 day) | 4.63 × 10⁻⁸ |

As illustrated in Table 1, by adding the oligomer solid acid according to an embodiment of the present invention, methanol crossover is slightly increased and ionic conductivity is greatly increased relative to the increase in methanol crossover. Therefore, when the solid acid according to an embodiment of the present invention is used, ionic conductivity may be greatly improved without affecting methanol crossover. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An oligomer solid acid comprising:
(a) a main chain having a degree of polymerization of 10 to 70; and
(b) a side chain having the structure represented by Formula 1 bonded to a repeating unit of the main chain:
-E₁- . . . -Eᵢ- . . . -Eₙ Formula 1
where each Eᵢ included in E₁ through Eₙ₋₁ is independently one of the organic groups represented by Formula 2 through Formula 6, 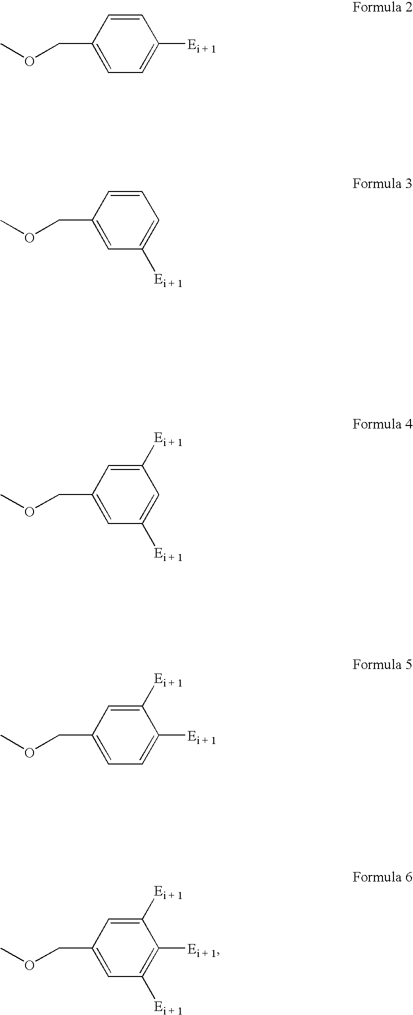
where each Eᵢ₊₁ of Formula 4 through Formula 6 can be independently the same or different,
the number of Eᵢ₊₁ of the (i+1)^{th} generation bonded with Eᵢ of the i^{th} generation is the same as the number of available bonds existing in Eᵢ,
n is an integer in the range of 2 to 4 and indicates the generation of a branching unit; and
Eₙ is one of —SO₃H, —COOH, —OH, and —OPO(OH)₂.

2. The oligomer solid acid of claim 1, wherein the repeating unit of the main chain is polystyrene, polyethylene, polyimide, polyamide, polyacrylate, polyamic ester, or polyaniline.

3. The oligomer solid acid of claim 2, wherein the repeating unit of the main chain is the repeating unit of one of Formula 7 through Formula 9.

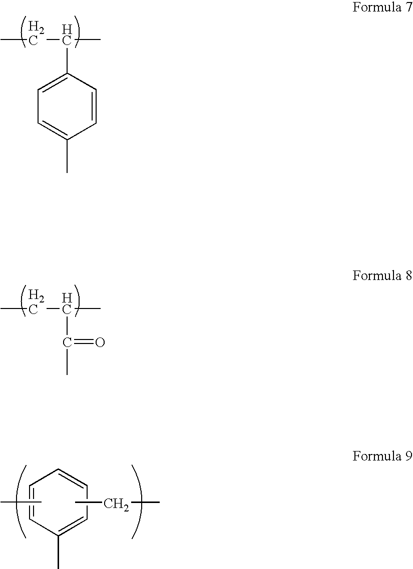

4. The oligomer solid acid of claim 1, wherein the side chain is the chain of one of Formula 10 through Formula 15:
Formula 10 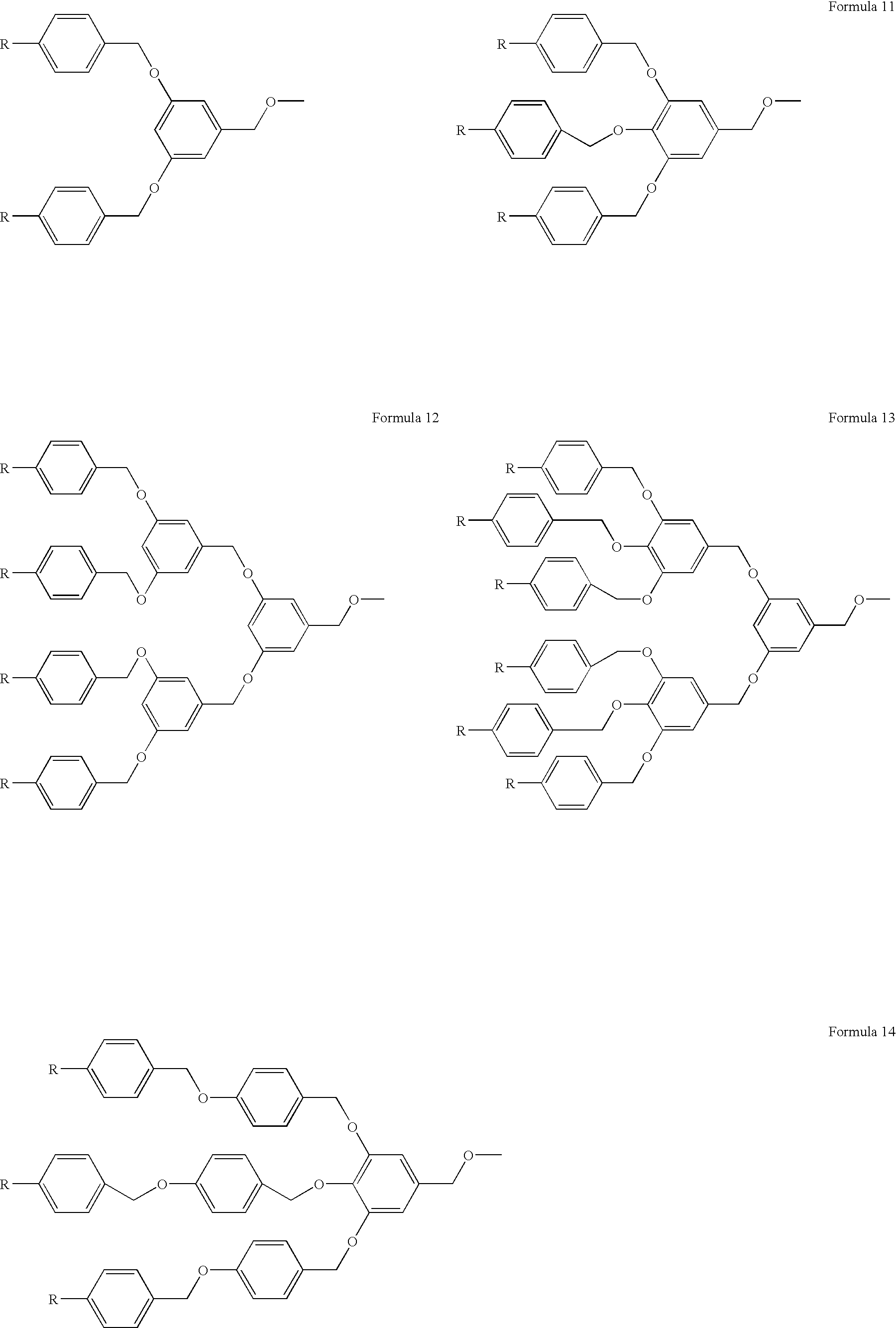 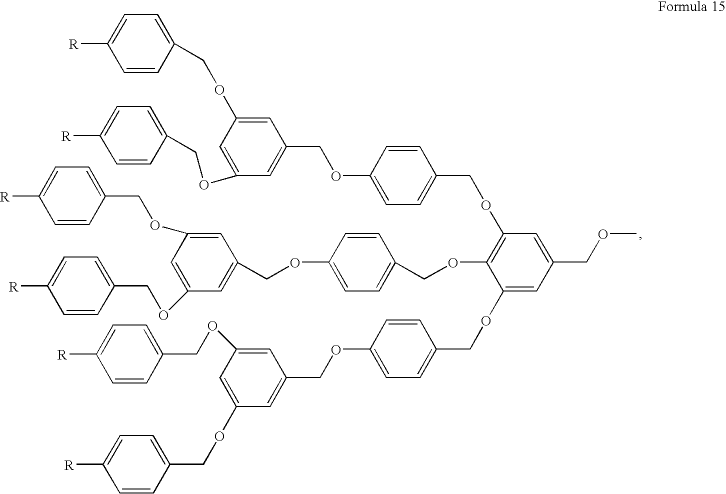
where R is one of —SO₃H, —COOH, —OH, and —OPO(OH)₂.

5. The oligomer solid acid of claim 1 having a molecular weight of 10,000 to 40,000.

6. A polymer electrolyte membrane comprising at least one polymer matrix having an end group selected from the group consisting of —SO₃H, —COOH, —OH, and —OPO(OH)₂ at the terminal of a side chain, and the oligomer solid acid of claim 1 uniformly distributed through the polymer matrixes.

7. The polymer electrolyte membrane of claim 6, wherein the polymer matrix is at least one polymer material selected from the group consisting of polyimide, polybenzimidazole, polyethersulfone, and polyether-ether-ketone.

8. The polymer electrolyte membrane of claim 6, wherein the polymer matrix is a polymer resin represented by Formula 16: 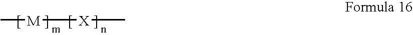
where M is a repeating unit of Formula 17, 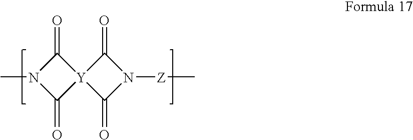
where Y is a tetravalent aromatic organic group or aliphatic organic group, and Z is a bivalent aromatic organic group or aliphatic organic group;
X is a repeating unit of Formula 18, 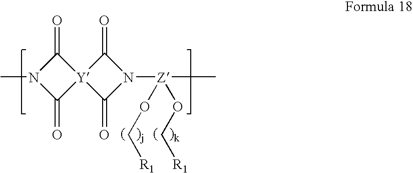
where Y′ is a tetravalent aromatic organic group or aliphatic organic group, Z′ is a tetravalent aromatic organic group or aliphatic organic group, j and k are each independently an integer in the range of 1 to 6, and R₁ is one of —OH, —SO₃H, —COOH, and —OPO(OH)₂; and
m and n are each in the range of 30 to 5000 and the ratio of m to n is in the range of 2:8 to 8:2.

9. A Membrane Electrode Assembly (MEA) comprising:
the polymer electrolyte membrane of claim 6,
a cathode on a first side of the polymer electrolyte membrane and having a catalyst layer and a diffusion layer; and
an anode on a second side of the polymer electrolyte membrane and having a catalyst layer and a diffusion layer.

10. A fuel cell comprising:
the polymer electrolyte membrane of claim 6;
a cathode on a first side of the polymer electrolyte membrane and having a catalyst layer and a diffusion layer; and
an anode on a second side of the polymer electrolyte membrane and having a catalyst layer and a diffusion layer.
